(19) United States
(12) Patent Application Publication
(10) Pub. No.: US 2026/0261010 A1
(43) Pub. Date: Sep. 3, 2026

(54) METHOD FOR MANUFACTURING AN ELECTROCHEMICAL CELL HAVING A SEPARATOR MEMBRANE WITH A NANO-CAGE COATING FOR SEPARATION OF ELECTRODES IN THE ELECTROCHEMICAL CELL AND A DEVICE THEREOF

(71) Applicant: Hong Kong Applied Science and Technology Research Institute Company Limited, Hong Kong (HK)

(72) Inventors: Tze Lok Andy CHAN, Hong Kong (HK); Yan Lung WONG, Hong Kong (HK); Xinying SUN, Hong Kong (HK); Yubo CHENG, Hong Kong (HK); Chun Lung CHOI, Hong Kong (HK); Fei ZHANG, Hong Kong (HK); Shengbo LU, Hong Kong (HK); Yong ZHU, Hong Kong (HK)

(21) Appl. No.: 19/655,745

(22) Filed: Apr. 23, 2026

Related U.S. Application Data
(63) Continuation-in-part of application No. 17/851,065, filed on Jun. 28, 2022, now Pat. No. 12,640,435.
(60) Provisional application No. 63/221,445, filed on Jul. 13, 2021.

(51) Int. Cl. H01M 50/403; H01M 10/0585; H01M 50/414; H01M 50/434; H01M 50/446; H01M 50/457; H01M 50/489

(52) U.S. Cl. CPC H01M 50/403; H01M 10/0585; H01M 50/414; H01M 50/434; H01M 50/446; H01M 50/457; H01M 50/489

(57) ABSTRACT

A method of manufacturing an electrochemical cell includes providing a cathode, an anode, an electrolyte, and a polymer separator membrane disposed between the electrodes. The polymer separator membrane is first irradiated at a first radiation dose for a first duration to modify the separator. The irradiated membrane is then plasma-treated to generate active surface sites, followed by applying a nano-cage precursor composition including nano-cage molecules and a photo-initiator, wherein the nano-cage molecules include cross-linkable functional groups such as epoxy groups and/or carbon-carbon double bonds. A second irradiation at a second radiation energy density is subsequently performed to cure the precursor layer and form an inside-out cross-linked nano-cage coating on the separator. The resulting coated separator exhibits a shrinkage rate of less than 5% at 150° C. and improves thermal stability, electrolyte wettability, anion stabilization, and capture of electrolyte byproducts.

### CROSS-REFERENCE OF RELATED APPLICATION

This application is a continuation-in-part of U.S. Non-provisional Utility Patent application Ser. No. 17/851,065 filed Jun. 28, 2022, which claims priority from U.S. Provisional Utility Patent Application No. 63/221,445 filed Jul. 13, 2021; the disclosure of which is incorporated by reference herein in its entirety.

### FIELD OF THE INVENTION

The invention relates to the technical field of electrochemical cells. In particular, it relates to a modified separator membrane for separation of electrodes in an electrochemical cell.

### BACKGROUND OF THE INVENTION

Lithium-ion batteries are used in a wide variety of electronic devices such as computers, mobile phones, and electric vehicles. In addition to the current applications, batteries are being considered for use in wearable electronics due to their high energy densities, stable cycle performances, and light weights. With the increase in capacity loading requirements for different practical applications, the need to meet safety standards for lithium-ion batteries has become a challenge. A thermally stable separator for separation of electrodes in the electrochemical cell is needed for a safe lithium-ion battery.

China Patent Publication No. CN103421208B discloses a preparation method of cross-linking a polyethylene porous diaphragm. The polyethylene porous diaphragm is soaked in a volatile solution containing an initiator and a cross-linking agent. The polyethylene porous diaphragm absorbs the initiator and cross-linking agent. The polyethylene porous diaphragm is irradiated. The initiator and cross-linking agent react, and then a cross-linking reaction is triggered to render the polyethylene porous diaphragm less susceptible to shrinkage at high temperatures.

China Patent Application Publication No. CN104882581A discloses a lithium-ion battery diaphragm and a preparation method thereof. The diaphragm is prepared by rinsing it in a solution having siloxane containing ethylene and a polymerization inhibitor. The irradiation of the diaphragm leads to a grafting reaction between the crosslinkers and polyethylene diaphragm. Korean Patent Publication No. KR102073852B1 discloses a silane-grafted polyolefin solution. This solution includes polyolefin having a weight average molecular weight of 200,000 or more, a diluent, an alkoxy group-containing vinylsilane, and an initiator. The solution facilitates cross-linking reaction. CN104882581A and KR102073852 employ chemicals to facilitate the cross-linking reaction. However, these treatments can only be applied during the separator extrusion process. For an already set and formed separator membrane, these chemical treatments cannot be used.

Conventional polyethylene (PE) separators suffer from several drawbacks, including thermal shrinkage at elevated temperatures, potential explosion risks, insufficient mechanical strength, and poor electrolyte wettability due to their nonpolar surface characteristics. Existing solutions such as ceramic coatings may improve thermal stability; however, they often increase separator thickness, thereby reducing the energy density of the battery. In addition, ceramic coatings may delaminate from the PE separator because of weak interfacial adhesion.

Accordingly, the present invention addresses these limitations by providing a separator structure capable of preventing thermal deformation at temperatures of about 150-200° C., enhancing mechanical strength without increasing separator thickness, and improving electrolyte affinity. The invention further reduces transition-metal crosstalk and CO₂ gas generation, while improving the rate capability and cycle performance of the battery. In particular, the proposed solution provides reinforced, polar, and functional nano-coatings that overcome the limitations associated with conventional PE separators and traditional coated separator systems.

### SUMMARY OF THE INVENTION

It is objective of the present invention to address the aforementioned shortcoming in the current state of the art.

In accordance with a first aspect of the present invention, a method of manufacturing an electrochemical cell having a polymer separator membrane with an inside-out cross-linked nano-cage coating for separation of electrodes in the electrochemical cell is provided. The method includes the following steps: providing a cathode; providing a polymer separator membrane; performing at least one cycle of irradiation on the polymer separator membrane by an energy beam under a radiation dose ranging between 50 and 200 kGy to effect a cross-linking in the polymer separator membrane, wherein the polymer separator membrane is maintained at a temperature between 3° and 70° C.; subjecting irradiated polymer separator membrane to a plasma treatment to generate active surface sites; applying a nano-cage precursor composition onto the plasma-treated surface of the polymer separator membrane to form a coating layer, wherein the nano-cage precursor composition comprises nano-cage molecules and a photo-initiator, and wherein the nano-cage molecules comprise cross-linkable functional groups comprising epoxy groups and/or carbon-carbon double bonds; performing a second irradiation at a second radiation energy density ranging from 1 to 10000 mJ/cm² using the ultraviolet light to cure the precursor coating layer and form an inside-out cross-linked nano-cage coating on the polymer separator membrane, wherein the inside-out cross-linked nano-cage coating is configured to improve the thermal stability, facilitate electrolyte wetting of the polymer separator membrane, stabilize anions, and capture electrolyte byproducts; providing an anode; compressing the polymer separator membrane between the cathode and the anode; and providing an electrolyte to form the electrochemical cell.

In accordance with one embodiment, the method further includes evaporating a solvent from the nano-cage precursor composition to form a thin precursor coating layer before performing the second irradiation.

In accordance with one embodiment, the nano-cage coating forms an ultra-thin cross-linked layer that improves thermal stability of the polymer separator membrane without substantially increasing separator thickness.

In accordance with one embodiment, after performing at least one cycle of irradiation on the polymer separator membrane by the energy beam the polymer separator membrane has a gel content of cross-linked polymer separator membrane between 30% and 90%.

In accordance with another embodiment, the polymer separator membrane is selected from the group consisting of polypropylene, polyethylene, polyvinylidene difluoride, polyimide, polyacrylonitrile or combinations thereof.

In accordance with yet another embodiment, after the compressing the polymer separator membrane between the cathode and the anode, the polymer separator membrane has a thickness in a range between 3 and 30 μm.

In accordance with yet another embodiment, the inside-out cross-linked nano-cage coating comprises a polyhedral oligomeric silsesquioxane (POSS) and at least one metal-organic cage (MOC).

In accordance with one embodiment, the POSS is identified by an infrared (IR) absorption band between 1000 and 1200 cm⁻¹ in a Fourier transform infrared spectroscopy (FTIR) spectrum, corresponding to the key chemical bonds (Si—O—Si).

In accordance with yet another embodiment, the at least one MOC includes metal clusters coordinated with organic ligands to form a porous cage structure having accessible internal cavities and open metal coordination sites capable of interacting with electrolyte species.

In accordance with yet another embodiment, the inside-out cross-linked nano-cage coating has a thickness of 0.1 to 50 nm.

In accordance with yet another embodiment, the step of providing a polymer separator membrane further includes: applying polymeric binders on opposing sides of the polymer separator membrane; and disposing a plurality of ceramic particles in the polymeric binders.

In accordance with yet another embodiment, the ceramic particles is selected from the group consisting of CaO nanoparticles, MgO nanoparticles, Al₂O₃ nanoparticles, B₂O₃ nanoparticles, SiO₂ nanoparticles, ZrO₂ nanoparticles, SnO₂ nanoparticles, nanoclay, or a combination thereof.

In accordance with yet another embodiment, the polymeric binder is selected from the groups consisting of silane, acrylate, epoxy, urethane, polyolefin, ether, and a combination thereof.

In accordance with yet another embodiment, the step of providing the polymer separator membrane further includes: manufacturing the polymer separator membrane by wet or dry extrusion, electrospinning, melt spinning, or a combination thereof.

In accordance with yet another embodiment, an electron beam performs at least one cycle of irradiating the polymer separator membrane.

In accordance with yet another embodiment, a gamma ray performs at least one cycle of irradiating the polymer separator membrane.

In accordance with yet another embodiment, a second irradiation is performed at an energy density ranging from 1 to 10000 mJ/cm² using the ultraviolet light to cure the precursor coating layer and form an inside-out cross-linked nano-cage coating.

In accordance with a second aspect of the present invention, an electrochemical cell is provided. The electrochemical cell includes: a cathode; an anode; an electrolyte; and a coated polymer separator membrane disposed between the cathode and the anode; wherein the coated polymer separator membrane comprises an inside-out cross-linked nano-cage coating; wherein the coated polymer separator membrane is fabricated by performing a first irradiation to a polymer separator membrane using an energy beam at a first radiation dose for a first duration to modify the polymer separator membrane; subjecting the irradiated polymer separator membrane to a plasma treatment to generate active surface sites; applying a nano-cage precursor composition onto the plasma-treated surface of the polymer separator membrane to form a coating layer; performing a second irradiation at a second radiation energy density using the UV light to cure the precursor coating layer and form the inside-out cross-linked nano-cage coating of the polymer separator membrane; wherein the nano-cage precursor composition comprises nano-cage molecules and a photo-initiator, and wherein the nano-cage molecules comprise cross-linkable functional groups comprising epoxy groups and/or carbon-carbon double bonds; wherein the inside-out cross-linked nano-cage coating is in an ultra-thin form that increases thermal stability of the polymer separator membrane without substantially increasing separator thickness; wherein the first radiation dose is ranging from 100 to 200 kGy; and wherein the second radiation energy density is ranging from 1 to 10000 mJ/cm².

In accordance with one embodiment, the inside-out cross-linked nano-cage coating improves electrolyte wettability of the separator membrane.

In accordance with another embodiment, the inside-out cross-linked nano-cage coating captures electrolyte decomposition byproducts.

In accordance with yet another embodiment, the coated separator membrane suppresses dendrite growth between the anode and cathode.

### BRIEF DESCRIPTION OF THE DRAWINGS

In order to more clearly illustrate the technical solutions of the embodiments of the present invention, the drawings needed to be used in the description of the embodiments will be briefly introduced below. It is obvious that the drawings in the following description are only some embodiments of the present invention, and it is obvious for those skilled in the art to obtain other drawings based on these drawings without inventive exercise, in which:

FIGS. 1A, 1B, 1C, 1D, and 1E are schematic diagrams showing a method of manufacturing an electrochemical cell having a polymer separator membrane for separation of electrodes in the electrochemical cell according to an embodiment of the present invention;

FIG. 2 is an enlarged view of area A in FIG. 1E showing representative cross-linking structure of a polymer separator membrane for separation of electrodes in the electrochemical cell according to an embodiment of the present invention;

FIGS. 3A, 3B, 3C, 3D, and 3E are schematic diagrams showing a method of manufacturing an electrochemical cell by a polymer separator membrane and polymeric binders with ceramic particles;

FIG. 4 is an enlarged view of area B in FIG. 3C showing the bonding relationship between the irradiated polymer separator membrane;

FIG. 5 is a differential scanning calorimetry (DSC) analysis graph of Examples 1 to 4 and a Comparative Example 1;

FIGS. 6A, 6B, 6C, 6D, and 6E are SEM images of Examples 5 to 8 and a Comparative Example 2 respectively;

FIGS. 7A, 7B, 7C, 7D, and 7E are SEM images of Example 5 to 8 and a Comparative Example 2 respectively after 140° C. heat treatment for 1 hour;

FIGS. 8A and 8B are schematic diagrams of a hot nail test for a separator membrane;

FIGS. 9A and 9B are schematic diagrams of a hot nail test for a polymer separator membrane according to an embodiment of the present invention;

FIGS. 10A, 10B, and 10C are schematic diagrams of a hot nail test for a separator membrane;

FIGS. 11A, 111B, 11C, 11D, 11E, 11F, 11G and 11H are schematic diagrams showing a method of manufacturing an electrochemical cell having a polymer separator membrane with a nano-cage coating for separation of electrodes in the electrochemical cell according to an embodiment of the present invention;

FIGS. 12A and 12B depict the thickness of non-coated separator film (FIG. 12A) and separator film with nano-cage coating (FIG. 12B);

FIGS. 13A and 13B depict the results of 150° C. thermal shrinkage test of a separator having a nano-cage coating;

FIG. 14 depicts a comparison of the 150° C. thermal shrinkage test results for different separators;

FIG. 15 depicts the rate test comparison between non-coated and coated (30% A-POSS solution coating) separators; and

FIG. 16 depicts the rate test comparison between non-coated and coated (1% A-POSS solution coating) separators.

### DETAILED DESCRIPTION

In the following description, numerous specific details are set forth in order to provide a thorough understanding of the present invention, but the present invention may be practiced in other ways than those specifically described and will be readily apparent to those of ordinary skill in the art without departing from the spirit of the present invention, and therefore the present invention is not limited to the specific embodiments disclosed below.

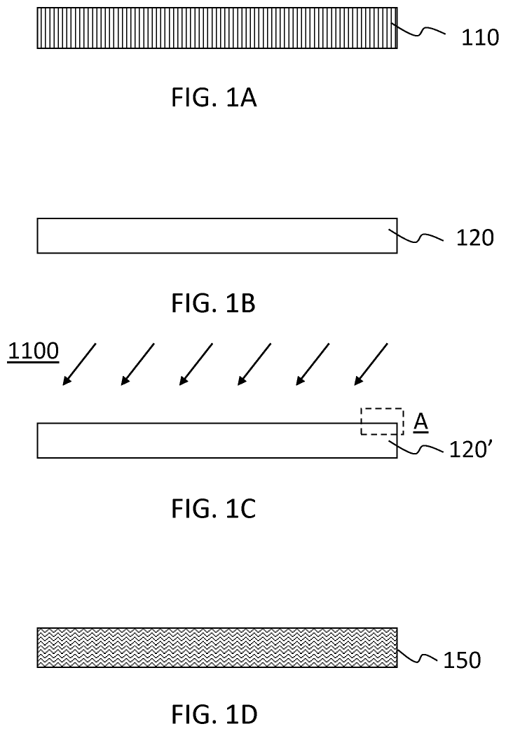

The present invention provides a method of manufacturing an electrochemical cell having a polymer separator membrane for separation of electrodes in the electrochemical cell. Referring to FIG. 1A, a cathode 110 is provided. The cathode is alkaline metal salts, transition metal salts, and their complexes. Next, turning to FIG. 1B, a polymer separator membrane 120 is provided. The polymer separator membrane 120 is in the shape of a plane and has at least two flat surfaces opposite each other. The polymer separator membrane 120 can be made from polypropylene, polyethylene, polyvinylidene difluoride, polyimide, polyacrylonitrile or combinations thereof. The polymer separator membrane can be made by wet or dry extrusion, electrospinning, melt spinning, or a combination thereof.

Referring to FIG. 1C, the polymer separator membrane 120 undergoes irradiation. An energy beam 1100 is shone onto the polymer separator membrane 120. In one embodiment, the energy beam 1100 is an electron beam. In another embodiment, the energy beam 1100 is a gamma ray. The energy beam has a radiation dose ranging between 50 and 200 kGy. The duration of irradiation may fall between 1 hour to 20 hours or 1 hour to 4 hours. An irradiation ambient temperature has to be kept between 40° C. and 100° C.

Under high-radiation-dose irradiation, for example, above 80 kGy, heat generates inside the separators. The temperature of the polymer separator membrane may increase beyond a shrinkage threshold or even the melting point of the polymer separator membrane. Interspersed irradiation during a longer period of time can prevent heat damage under high-radiation-dose irradiation. For example, if the temperature exceeds 120° C., a significant shrinkage of the polymer separators membrane may happen. In one embodiment, the irradiation occurs in more than one cycle. For instance, a first irradiation is performed under 50 kGy for 1 hour, and the polymer separator temperature is maintained between 30° C. and 50° C. A second irradiation is performed under 100 kGy for 2 hours, and the polymer separator membrane temperature is maintained between 30° C. and 70° C. It should be understood that different combinations of the radiation dose, duration, and temperature all fall into the scope of the present invention given that those values are within the provided range.

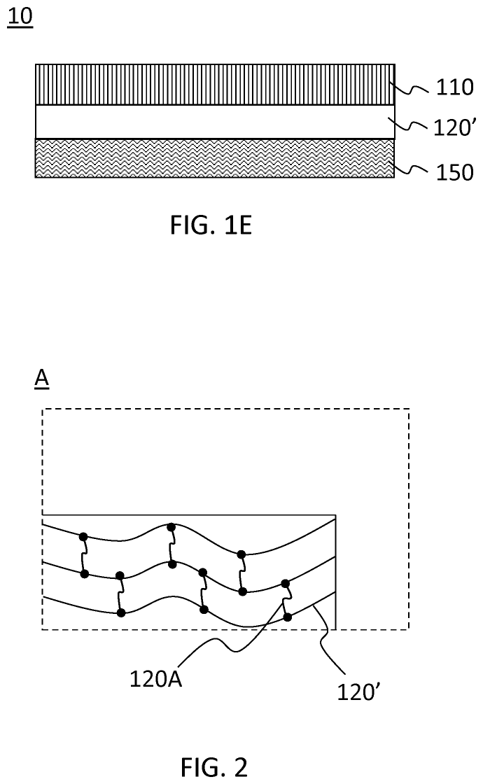

Referring to FIG. 2, an enlarged view of area A, as indicated in FIG. 1C, is shown. FIG. 2 is a representative schematic diagram showing the bonding relationship among the irradiated polymer separator membrane 120′. After the irradiation by the energy beam 1100, free radicals of the polymer separator membrane are excited, and cross-linking reaction takes place within the irradiated polymer separator membrane 120′ to form cross-linking chemical bonds 120A.

The extent of cross-linking in the polymer separator membrane 120′ is assessed by the standard method of gel content (insoluble fraction). Measurements of the gel content of the irradiated polymer separator membrane 120′ are obtained according to the standard of ASTM D-2765, using a 20 h Soxhlet extraction cycle, with p-xylene as the solvent at 150° C. Irganox 1010 is added at 0.5 wt % to inhibit polymer separator membrane 120′ degradation during the extraction. Approximately 0.3 g of the irradiated polymer separator membrane 120′ is cut into small pieces and placed in a pre-weighted stainless steel fine wire mesh. After the extraction cycle, the sample is washed with acetone and vacuum dried to a constant weight. The gel content (gel fraction) is calculated as the percentage ratio of the final weight of the polymer to its initial weight. The irradiated polymer separator membrane 120′ has a gel content (gel fraction) in a range between 30% and 90%.

Referring to FIG. 1D, an anode 150 is provided. The anode 150 can be made from graphene based complex or lithium metal. Referring to FIG. 1E, the irradiated polymer membrane 120′, the cathode 110, and the anode 150 are compressed together. The irradiated polymer membrane 120′ is placed between the cathode 110 and the anode 150. After compression, the irradiated polymer membrane 120′ has a thickness in a range between 3 μm and 30 μm. Subsequently, an electrolyte (not shown) is provided. An electrochemical cell 10 in accordance with an embodiment of the present invention is completed. The shrinkage rate of the formed separator is less than 30% at 140° C. In one embodiment, the shrinkage rate of the irradiated polymer membrane 120′ is less than 25% at 140° C.

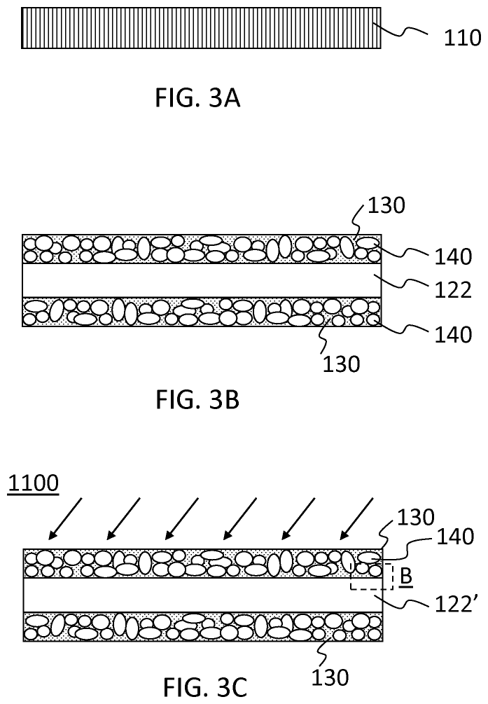

In one embodiment, ceramic particles in polymeric binders are used with the polymer separator membrane. Referring to FIG. 3A, a cathode 110 is provided. The cathode is alkaline metal salts, transition metal salts, and their complexes. Next, turning to FIG. 3B, a polymer separator membrane 122 is provided. The polymer separator membrane 120 is in the shape of a plane and has at least two flat surfaces opposite each other. The polymer separator membrane 120 can be made from polypropylene, polyethylene, polyvinylidene difluoride, polyimide, polyacrylonitrile or combinations thereof. The polymer separator membrane can be made by wet or dry extrusion, electrospinning, melt spinning, or a combination thereof. For the purpose of clarity, the cathode 110 is not shown in FIGS. 3B to 3D. A coating is formed on the polymer separator membrane 122. The coating includes polymeric binders and ceramic particles. The polymeric binders 130 are applied on the opposing surfaces of the polymer separator membrane 122. The polymeric binders 130 are applied on the polymer separator membrane 122 through various coating processes such as dip coating, spray coating, or doctor blade coating. The polymeric binders 130 can be made from silane, acrylate, epoxy, urethane, polyolefin, ether, or a combination thereof. A plurality of ceramic particles 140 is disposed in the polymeric binders 130. The ceramic particles 140 are disposed in the polymeric binders 130 by spray coating, dip coating, doctor blade coating, pad-dry-cure coating or wiping. The ceramic particles 140 can be made from CaO nanoparticles, MgO nanoparticles, Al₂O₃ nanoparticles, B₂O₃ nanoparticles, SiO₂ nanoparticles, ZrO₂ nanoparticles, SnO₂ nanoparticles, nanoclay, or a combination thereof. An individual ceramic particle 140 has a particle size between 10 nm and 100 nm or between 10 nm and 50 nm. In one embodiment, the ceramic particles 140 that have a particle size between 10 nm and 50 nm bind more tightly to the surface of the polymer separator membrane 122. The resulting electrochemical cell features a thinner profile, which is associated with higher thermal resistance.

Referring to FIG. 3C, the polymer separator membrane 122, the polymeric binders 130, and the ceramic particles 130 undergo irradiation. An energy beam 1100 is shone onto the polymer separator membrane 122. As previously discussed, the irradiation may be performed in more than one cycle under different combination of radiation dose and time period.

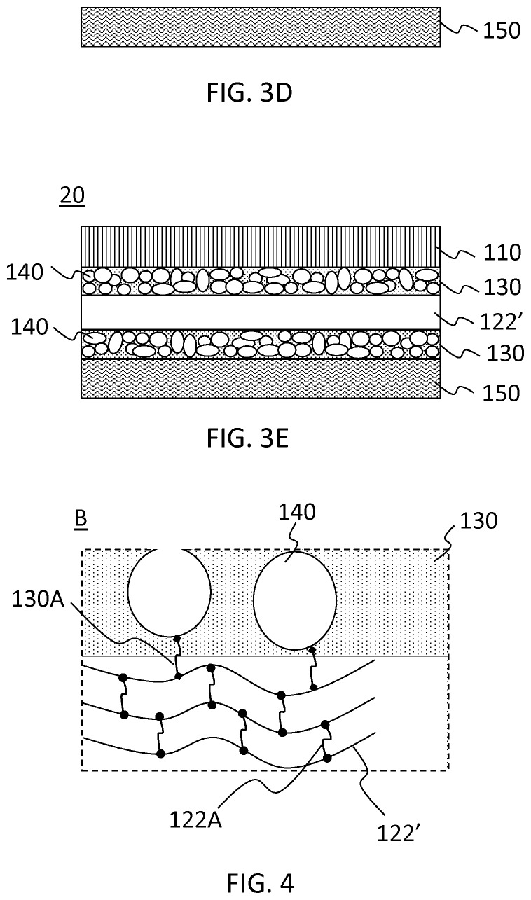

Referring to FIG. 4, an enlarged view of area B, as indicated in FIG. 3C, is shown. FIG. 4 is a representative schematic diagram showing the bonding relationship between the irradiated polymer separator membrane 122′. After the irradiation by the energy beam 1100, a cross-linking reaction takes place within the irradiated polymer separator membrane 122′ to form cross-linking chemical bonds 120A. The ceramic particles 140 are joined with the polymer separator membrane 122′ through the polymeric binder bond 130A. The irradiated polymer separator membrane 122′ has a gel content (gel fraction) in a range between 30% and 90%.

Referring to FIG. 3D, an anode 150 is provided. The anode 150 can be made from graphene-based complex or lithium metal. Referring to FIG. 3E, the irradiated polymer membrane 122′, the cathode 110, the anode 150 are compressed together. The irradiated polymer membrane 122′ is placed between the cathode 110 and the anode 150. After compression, the irradiated polymer membrane 122′ and the polymeric binders 130 and ceramic particles 140 have a combined thickness in a range between 3 and 30 μm. Subsequently, an electrolyte (not shown) is provided. An electrochemical cell 20 in accordance with an embodiment of the present invention is completed. The shrinkage rate of the formed separator is less than 30% at 140° C. In one embodiment, the shrinkage rate of the irradiated polymer membrane 120′ is less than 25% at 140° C.

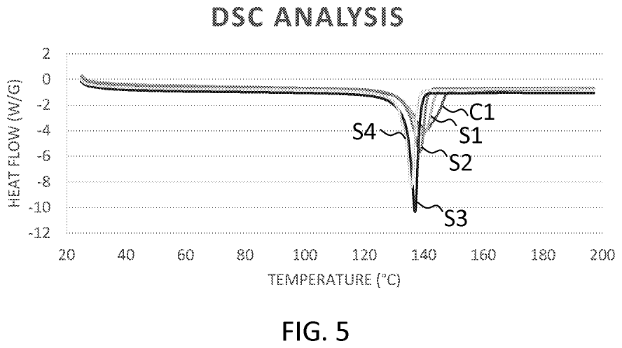

Referring to FIG. 5, a differential scanning calorimetry (DSC) graph is shown. The irradiated polymer separator membranes of samples 1 to 4 (S1 to S4) are made from pure polyethylene in a dimension of 1.5 mg to 3 mg. Samples 1 to 4 are treated with different radiation doses of 50 kGy, 100 kGy, 150 kGy, and 200 kGy respectively. C1 represents a commercially available polymer separator membrane. The testing profile has an equilibrium temperature at 25° C., and the temperature is raised at 10° C./min to 200° C. The melting points and the enthalpies (ΔH) of the samples are shown in Table 1.

TABLE 1

| | Melting point (° C.) | Enthalpy of fusion (J/g) |
|---|---|---|
| S1 | 139.71 | 177.0 |
| S2 | 138.75 | 179.2 |
| S3 | 137.10 | 240.0 |
| S4 | 135.95 | 212.7 |
| C1 | 140.82 | 203.3 |

As shown in FIG. 5, the melting grooves of samples 1 to 4 are much sharper compared to C1. In other words, samples 1 to 4 demonstrated faster phase change. In Table 1, samples 3 and 4 have higher enthalpy compared to sample C1. It indicates that the heat capacities of Samples 3 and 4 are higher, and thereby samples 3 and 4, which are treated with 150 kGy and 200 kGy respectively, have greater thermal stability. Moreover, there is a trend of shifting melting grooves from higher temperature to the lower ones. Specifically, sample C1 has a melting point of 140.82° C., and the melting points gradually decrease from samples S1 to S4. There is a negative correlation with the radiation dose and the melting point. When the radiation dose is higher, for example, 200 kGy, the melting point is the lowest among the 5 samples.

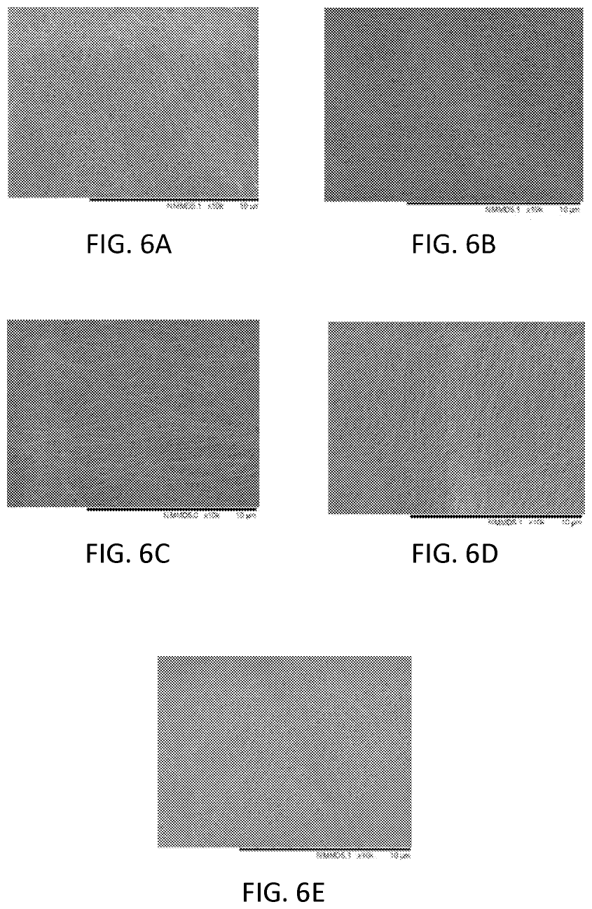

Referring to FIGS. 6A to 6E, SEM analysis images of irradiated polymer separator membranes of samples S5 to S8 and a comparative sample 2 (C2) are shown respectively. It can be seen that after irradiation and without cross-linking agent or initiators, samples S5 to S8, as shown in FIGS. 6A to 6D, show similar morphology as the sample C2, as shown in FIG. 6E. The SEM analysis suggests that the irradiation treatment does not result in morphology change to the irradiated polymer separator membranes.

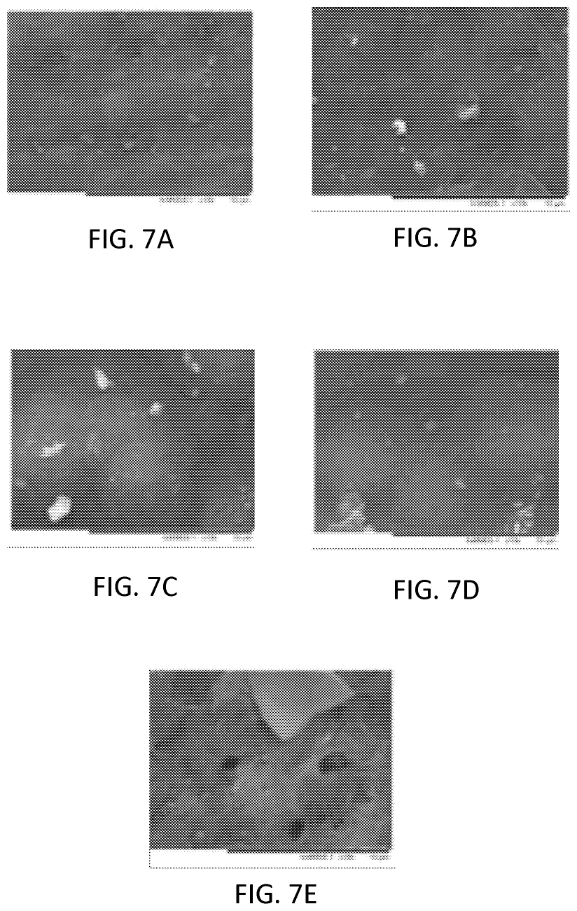

Referring to FIGS. 7A to 7E, SEM analysis is shown after samples S5 to S8 and sample C2 are exposed under 140° C. heat treatment for 1 hour. Samples S5 to S8 are treated with different radiation doses of 50 kGy, 100 kGy, 150 kGy, and 200 kGy respectively. Referring to FIG. 7E, sample C2, which does not undergo irradiation, shows sizable holes and fragmentation after the heat treatment. This is the result of the lack of irradiation treatment to the polymer separator membrane which can be translated as a high shrinkage rate. Referring to FIGS. 7A to 7D, samples S5 to S8 have relatively smooth surfaces after heat treatment. No holes are observed on the irradiated polymer separator membrane. That is, the irradiated polymer separator membrane has higher heat resistance and a lower shrinkage rate.

### Thermal Shrinkage Test

Samples S5 to S8 and samples C1 and C2 undergo the following procedure for the thermal shrinkage test. This test simulates the condition when a separator membrane for electrodes in an electrochemical cell is under high temperature. Step 1, an anode is wrapped with a piece of separator membrane and placed into a pouch. Step 2, the pouch is dried at 90° C. Step 3, the dried pouch is placed in a glovebox. Step 4, the anode with the separator membrane is immersed in an electrolyte for 24 hours. Step 5, the anode and separator membrane (in an Al/cPP [cast polypropylene]) are vacuum sealed in a sealing pouch. Step 6, the pouch is heated at 140° C. (±3° C.) for 1 hour. Step 7, the sealing pouch is opened to check the status of the anode and separator membrane.

The shrinkage rate shown in Table 3 is obtained according to the following equation:

$$\frac{{A}_{i} - {A}_{f}}{{A}_{i}}$$

Aᵢ is the initial coverage area of the separator membrane, and A_{f} is the final coverage area of the separator membrane. The results are shown in Table 3.

TABLE 3

| | S5 | S6 | S7 | S8 | C1 | C2 |
|---|---|---|---|---|---|---|
| Shrinkage rate | 20% | 20% | 10% | 10% | 50% | 50% |

The calculated shrinkage rates of samples S5 to S8 are lower than the shrinkage rates of samples C1 and C2. In addition, due to the high shrinkage rate, large area of anodes of samples C1 and C2 is exposed, and the electrochemical batteries cease to function. Samples S5 to S8 remain functional because the irradiated separator membrane has a high thermal resistance and low shrinkage rate especially under high working temperature.

The melting point of the polymer separator membrane is in the range between 130° C. and 145° C. In TD direction, when the temperature rises to approximately 150° C., the unirradiated polymer separator membrane shows the greatest shrinkage rate at −59%. An irradiated polymer separator membrane that undergoes 50 kGy electron beam or gamma ray treatment impedes shrinkage to −56%. An irradiated polymer separator membrane that undergoes 100 kGy electron beam or gamma ray treatment impedes shrinkage to a greater extent of −49%. An irradiated polymer separator membrane that undergoes 150 kGy electron beam or gamma ray treatment impedes shrinkage to the highest of −40%.

In MD direction, when the temperature rises to approximately 150° C., the unirradiated polymer separator membrane shows shrinkage rate to −70%. An irradiated polymer separator membrane that undergoes 100 kGy electron beam or gamma ray treatment impedes shrinkage to −66%. An irradiated polymer separator membrane that undergoes 150 kGy electron beam or gamma ray treatment impedes shrinkage to −60%.

### Hot Nail Penetration Test

A hot nail penetration test is conducted to investigate the heat resistance of the irradiated polymer separator membrane. Sample S9 is prepared in accordance with an embodiment of the present invention with an irradiated PE separator membrane. Sample S9 is subjected to a radiation dose of 150 kGy electron beam/gamma ray. A comparative sample C3 is a PE separator membrane without irradiation. Before the hot nail penetration test, all the samples are intact. The samples are placed underneath a hot iron nail which has a diameter of 5.5 mm. The hot iron nail makes contact twice with the samples. The diameters of the holes appearing on the samples are recorded. The morphology observation results are illustrated as cartoon diagrams.

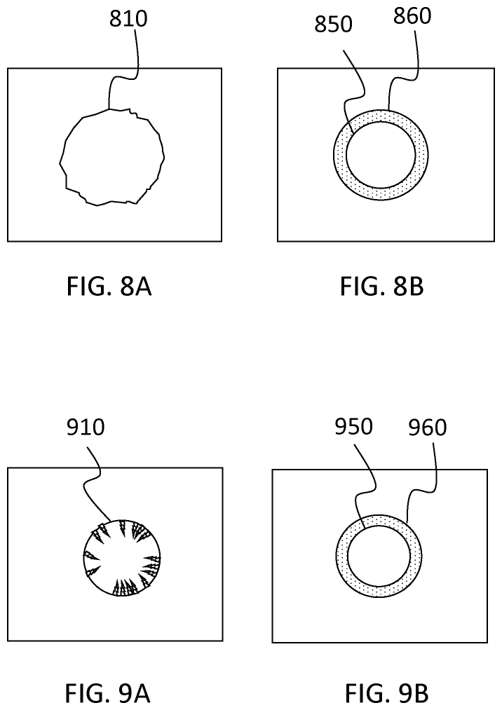

Referring to FIGS. 8A and 8B, the hot iron nail test on samples C3 and S9 is conducted at 186° C. Referring to FIG. 8A, after contact with the hot iron nail at 186° C., sample C3 shows a naked-eye-visible melting collapse 810 of the untreated polymer separator membrane. Referring to FIG. 8B, after contact with the hot iron nail at 186° C., a hole 850 appears on sample S9, and a ring of thin and semi-transparent irradiated polymer separator membrane is observed. In other words, the irradiated polymer separator membrane 860 of sample S9 holds its shape and exerts higher heat resistance, thus protecting its immediately adjacent components by blocking any heat transmission.

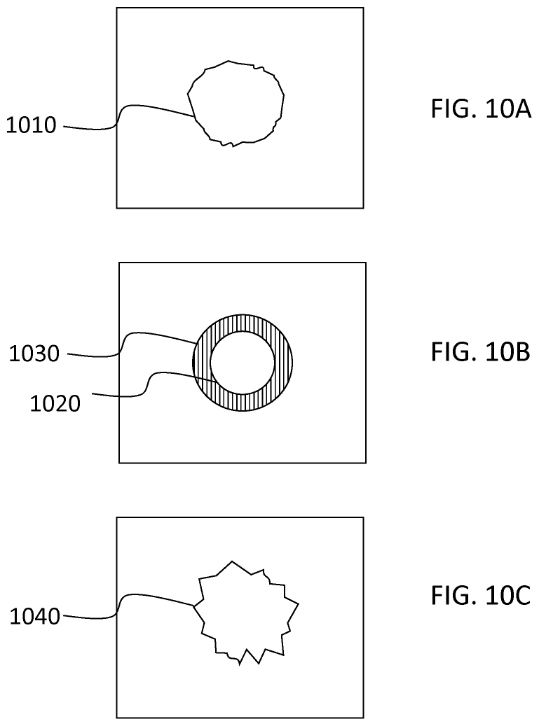

Referring to FIGS. 9A and 9B, the hot iron nail test to sample C3 and S9 is conducted at 320° C. (temperature of the iron nail). Referring to FIG. 9A, after contact with the hot iron nail at 320° C., a hole 910 appears and has naked-eye-visible frizzle fringes. Referring to FIG. 9B, after contact with the hot iron nail at 320° C., a hole 950 appears on sample S9, and a ring of thin and semi-transparent irradiated polymer separator membrane is observed. The irradiated polymer separator membrane 960 of sample S9 shows a stronger heat resistance in comparison with untreated sample C3.

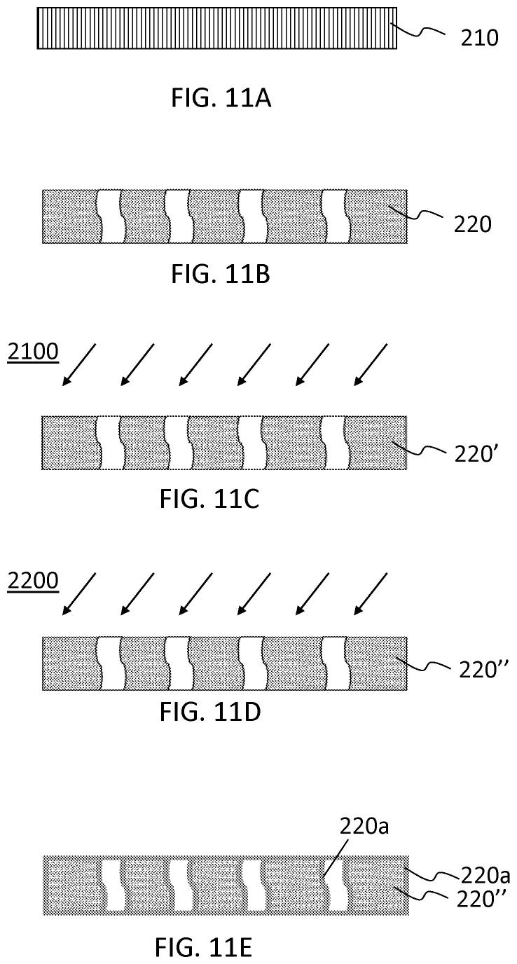

Referring to FIGS. 10A to 10C, a hot nail penetration test is performed under a different set of conditions. In this test, the separator membranes are subjected to contact with a 320° C. hot iron nail for 10 seconds. FIG. 10A shows an irradiated separator membrane that is treated with a radiation dose of 100 kGy gamma ray. After the hot iron nail test, a hole 1010 appears and minor frizzle at the edge of the irradiated separator membrane can be observed. In general, the hole 1010 still holds its shape and has neglectable phase change. FIG. 10B shows an irradiated separator membrane that is treated with a radiation dose of 150 kGy gamma ray. A hole 1020 appears, which has a smaller diameter than the other hole 1010. A ring of the irradiated polymer separator membrane 1030 becomes thinner and more transparent around the hole 1020. It suggests that the irradiated polymer separator membrane 1030 undergoes melting to a lesser extent on the membrane, and hence the semi-transparent appearance. These results show that the irradiated separator membrane can effectively protect its immediate components from heat damage and undergo minor phase change. FIG. 10C shows a regular polymer separator membrane without irradiation undergoing the hot iron nail test. Conspicuous heat damage to the polymer separator membrane can be observed, including melting and frizzle.

In another aspect of the present invention, the present invention introduces an ultra-thin nano-coating, on the order of a few nanometers, comprising POSS/MOC cage molecules. Unlike conventional ceramic coatings that increase separator thickness and reduce battery energy density, the disclosed nano-coating provides internal reinforcement without substantially increasing the thickness of the separator. The nano-cage structures exhibit high thermal stability, binder-free crosslinking capability, and strong mechanical reinforcement, thereby improving separator durability. In addition, the coating surface is highly polar, which enhances electrolyte wettability. The nano-cage structures further include accessible metal sites capable of stabilizing anions and capturing transition-metal by-products, thereby reducing detrimental interfacial reactions within the battery.

The present invention provides a method of manufacturing an electrochemical cell having a polymer separator membrane with an inside-out cross-linked nano-cage coating for separation of electrodes in the electrochemical cell. The method includes providing a cathode and providing a polymer separator membrane configured to be positioned between opposing electrodes of the electrochemical cell. The polymer separator membrane is subjected to at least one cycle of irradiation using an energy beam under a radiation dose ranging between 50 and 200 kGy to induce cross-linking within the polymer separator membrane. During the irradiation process, the polymer separator membrane is maintained at a temperature between 3° and 70° C. so as to promote controlled cross-linking while preserving structural integrity. Following the irradiation treatment, the irradiated polymer separator membrane is subjected to a plasma treatment to generate active surface sites on the membrane surface. The activated surface facilitates subsequent coating adhesion and chemical bonding. A nano-cage precursor composition is then applied onto the plasma-treated surface of the polymer separator membrane to form a coating layer. The nano-cage precursor composition includes nano-cage molecules and a photo-initiator. The nano-cage molecules include cross-linkable functional groups comprising epoxy groups and/or carbon-carbon double bonds, thereby enabling further curing and network formation. Thereafter, the coated polymer separator membrane is subjected to a second irradiation using ultraviolet light at a second radiation energy density ranging from 1 to 10000 mJ/cm² to cure the precursor coating layer and form an inside-out cross-linked nano-cage coating on the polymer separator membrane. In certain embodiments, the resulting inside-out cross-linked nano-cage coating is configured to improve thermal stability of the separator membrane, facilitate electrolyte wetting of the polymer separator membrane, stabilize anions within the electrolyte environment, and capture electrolyte decomposition byproducts. After formation of the coated separator membrane, an anode is provided, and the polymer separator membrane is compressed between the cathode and the anode to establish an electrode assembly. An electrolyte is then introduced to complete formation of the electrochemical cell. Through the foregoing process, an electrochemical cell having an enhanced separator membrane with improved thermal, mechanical, and electrochemical performance may be obtained.

As used herein, the term “nano-cage coating” refers to a coating layer comprising nanoscale cage-structured materials having internal cavities or cage-like frameworks formed by inorganic or metal-organic structures. Such nano-cage structures include, but are not limited to, polyhedral oligomeric silsesquioxane (POSS), metal-organic cages (MOCs), metal-organic frameworks (MOFs), or combinations thereof, which provide nanoscale cavities, accessible pores, or open coordination sites capable of interacting with electrolyte species and stabilizing ionic components.

MOCs, featuring accessible cavities, rich surface chemistry, and excellent solution processability, represent promising materials for coating technologies used in battery separators. The discrete polyhedral structures of MOCs arise from the geometry of organic ligands and the connectivity of metal clusters, enabling tunable cavity sizes and shapes that can effectively and selectively host targeted chemical species.

In the present invention, novel MOC materials having acrylate functional groups and high polarity are designed. On one hand, the acrylate groups enable co-polymerization with POSS monomers, thereby forming an ultra-thin coating layer throughout the separator substrates. On the other hand, the polar ligands, such as tetrafluoro terephthalate, enhance the electrolyte wettability of the separator and thereby improve lithium-ion transport across the separator.

In addition, the positively charged metal clusters present in the MOC structures provide multiple anionophilic sites capable of binding anions of lithium salts as well as intermediate species (e.g., formic acid, oxalic acid, and methyl carbonate ions) generated from electrolyte decomposition. These favorable host-guest interactions can stabilize or deactivate the anions and reactive intermediates, thereby interrupting gas-generation pathways and improving the overall stability of the electrochemical system.

In some embodiments, after the nano-cage precursor composition is applied onto the plasma-treated surface of the polymer separator membrane, a solvent present in the nano-cage precursor composition is evaporated to form a thin precursor coating layer prior to performing the second irradiation. In certain embodiments, the nano-cage coating forms an ultra-thin cross-linked layer that improves the thermal stability of the polymer separator membrane without substantially increasing the thickness of the separator.

After performing at least one cycle of irradiation on the polymer separator membrane using the energy beam, the polymer separator membrane may exhibit a gel content of cross-linked polymer separator membrane between 30% and 90%. The polymer separator membrane used in the present invention may be selected from polypropylene, polyethylene, polyvinylidene difluoride, polyimide, polyacrylonitrile, or combinations thereof.

In certain embodiments, after compressing the polymer separator membrane between the cathode and the anode, the polymer separator membrane may have a thickness ranging from 3 μm to 30 μm.

In some embodiments, the inside-out cross-linked nano-cage coating includes POSS and at least one MOC. The POSS component may be identified by an infrared absorption band between 1000 and 1200 cm⁻¹ in a Fourier transform infrared spectroscopy (FTIR) spectrum, corresponding to the Si—O—Si chemical bonds characteristic of the POSS structure. In certain embodiments, the at least one metal-organic cage comprises metal clusters coordinated with organic ligands to form a porous cage structure having accessible internal cavities and open metal coordination sites capable of interacting with electrolyte species.

In some embodiments, the inside-out cross-linked nano-cage coating may have a thickness ranging from 0.1 nm to 50 nm.

In additional embodiments, the polymer separator membrane may further include polymeric binders applied on opposing sides of the polymer separator membrane, and a plurality of ceramic particles disposed within the polymeric binders. The ceramic particles may be selected from CaO nanoparticles, MgO nanoparticles, Al₂O₃ nanoparticles, B₂O₃ nanoparticles, SiO₂ nanoparticles, ZrO₂ nanoparticles, SnO₂ nanoparticles, nanoclay, or combinations thereof, which can enhance thermal resistance and mechanical stability of the separator membrane.

The polymeric binder used to support the ceramic particles may include materials selected from silane, acrylate, epoxy, urethane, polyolefin, ether, or combinations thereof, thereby providing adhesion between the ceramic particles and the polymer separator membrane while maintaining flexibility and chemical compatibility.

The polymer separator membrane itself may be fabricated using conventional membrane manufacturing techniques. In some embodiments, the polymer separator membrane is manufactured by wet extrusion, dry extrusion, electrospinning, melt spinning, or combinations thereof, allowing the formation of a porous polymer membrane structure suitable for electrolyte transport.

The energy beam used to perform the irradiation steps may be selected from various radiation sources according to various requirements. In certain embodiments, the first irradiation applied to the polymer separator membrane using the energy beam may be performed using an electron beam or a gamma ray. In some embodiments, the second irradiation used to cure the nano-cage precursor coating layer may be performed using ultraviolet radiation.

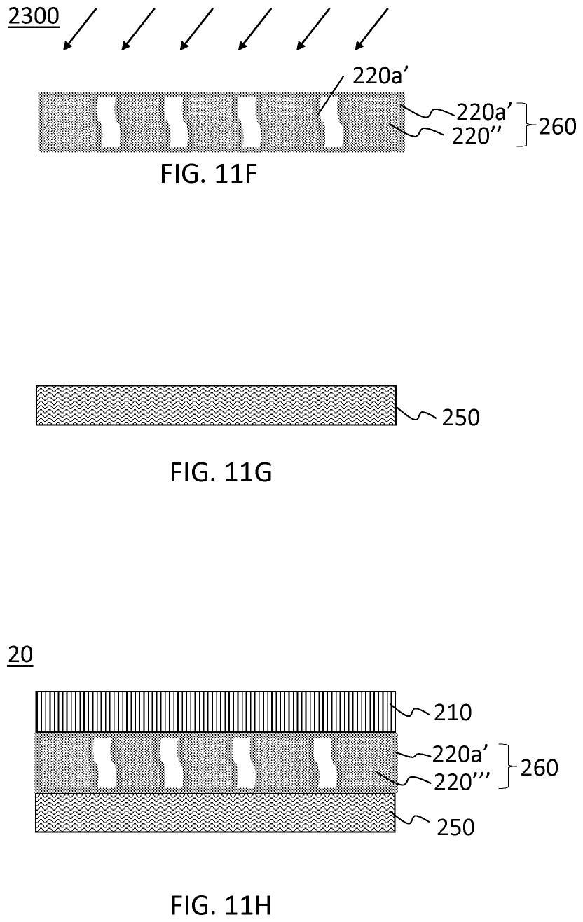

Referring to FIG. 11A, a cathode 210 is provided. The cathode is alkaline metal salts, transition metal salts, and their complexes. Next, turning to FIG. 11B, a polymer separator membrane 220 is provided. The polymer separator membrane 220 can be made from polypropylene, polyethylene, polyvinylidene difluoride, polyimide, polyacrylonitrile or combinations thereof. The polymer separator membrane can be made by wet or dry extrusion, electrospinning, melt spinning, or a combination thereof.

Referring to FIG. 11C, the polymer separator membrane 220 undergoes a first irradiation. First energy beam 2100 is shone onto a side of the polymer separator membrane 220, so that the overall polymer separator membrane 220 is irradiated and forms an irradiated polymer separator membrane 220′.

Referring to FIG. 11D, the first irradiated polymer separator membrane 220′ is subjected to a plasma treatment 2200 to generate active surface sites.

Referring to FIG. 11E, the plasma-treated polymer separator membrane 220″ is applied with a nano-cage precursor composition 220a.

Referring to FIG. 11F, second irradiation 2300 is shone onto the nano-cage precursor composition 220a applied side of the polymer separator membrane 220″ to cure the precursor coating layer and form an inside-out cross-linked nano-cage coating on the polymer separator membrane, forming a polymer separator membrane 220″ with a nano-cage coating 220a′. Together, a coated polymer separator 260 including a polymer separator membrane 220″ and an inside-out cross-linked nano-cage coating 220a′ is prepared.

The staged irradiation process provides various functions to the polymer separator. The first irradiation 2100 effect a cross-linking in the polymer separator membrane itself, and the second irradiation 2300 forms an inside-out cross-linked nano-cage coating in an ultra-thin form that increases thermal stability of the polymer separator membrane without substantially increasing separator thickness.

In one embodiment, the first radiation dose ranging from 100 kGy to 200 kGy using the energy beam, and the second radiation energy density is ranging from 1 to 10000 mJ/cm² using the UV irradiation.

Referring to FIG. 11G, an anode 250 is provided. The anode 250 can be made from graphene based complex or lithium metal. Referring to FIG. 11H, the coated polymer separator 260, the cathode 210, and the anode 250 are compressed together. The coated polymer separator 260 is placed between the cathode 210 and the anode 250. After compression, the coated polymer separator 260 has a thickness in a range between 3 and 30 μm. Subsequently, an electrolyte (not shown) is provided. An electrochemical cell 20 in accordance with an embodiment of the present invention is completed.

The nano-cage coating applied to the polymer separator membrane provides multiple structural and electrochemical advantages. The nano-cages exhibit high thermal stability, binder-free architecture, and high mechanical strength, thereby reinforcing the separator membrane without significantly increasing its thickness or mass. Due to the intrinsic rigidity of the cage structures and the strong inorganic framework of the nano-cages, the coating layer can withstand elevated temperatures and mechanical stresses encountered during battery operation. As a result, the separator membrane maintains structural integrity under thermal stress, thereby significantly enhancing battery safety. Importantly, these improvements are achieved without compromising the energy density of the electrochemical cell, since the nano-cage coating forms a thin and lightweight functional layer rather than a thick structural reinforcement.

The nano-cage structures possess high polarity and surface functionality, which facilitate improved wetting of polar electrolyte systems. The increased polarity of the nano-cage coating improves the affinity between the separator membrane and commonly used electrolyte solvents, allowing the electrolyte to rapidly infiltrate and uniformly distribute throughout the separator. This improved electrolyte wetting enhances ionic transport across the separator membrane and reduces electrolyte depletion at the electrode-separator interface.

Furthermore, the nano-cage structures may include accessible cavities and open metal sites, particularly in embodiments where the nano-cage coating includes MOCs. These porous structures provide active sites capable of interacting with electrolyte ions and reaction intermediates. In particular, the open metal sites within the cages may stabilize anionic species present in the electrolyte and capture undesired reaction byproducts generated during electrochemical cycling. The presence of these accessible cavities and active sites reduces the accumulation of interfacial degradation products, lowers interfacial resistance, and suppresses gas generation within the electrochemical cell. Through these mechanisms, the nano-cage coating contributes to improved electrochemical stability, reduced impedance growth, and enhanced cycling durability.

Accordingly, the nano-cage coating enables improvements in both rate performance and cycle life of the battery. The enhanced electrolyte wetting facilitates faster ionic transport during high-rate charging and discharging, while the stabilization of anions and capture of degradation byproducts helps maintain stable electrode-electrolyte interfaces over prolonged cycling.

The nano-cage coating technology described herein also provides several important technical merits from a manufacturing perspective. First, the coating layer may be applied using a water-based coating process combined with photo-initiated crosslinking, which is compatible with existing separator manufacturing lines. This approach allows the nano-cage coating to be integrated into conventional separator production processes without requiring major equipment modifications.

Second, the nano-cage coating provides integrated thermal and mechanical reinforcement to the separator membrane. The thin nano coating layer enhances separator robustness while maintaining a lightweight structure, thereby preserving the high energy density requirements of modern battery systems.

Third, the coating layer may be chemically functionalized, enabling the introduction of tailored surface functionalities that improve electrolyte wetting, stabilize ionic species, and enhance overall battery performance. Through such functionalization, the separator membrane can serve not only as a physical barrier between electrodes but also as an active interfacial component that improves electrochemical performance and operational stability.

Collectively, these features demonstrate that the nano-cage coated separator membrane provides a multifunctional platform that enhances battery safety, electrochemical performance, and manufacturing compatibility simultaneously.

In yet another aspect of the present invention, an electrochemical cell that includes a cathode, an anode, an electrolyte, and a coated polymer separator membrane disposed between the cathode and the anode, is provided. The coated polymer separator membrane comprises an inside-out cross-linked nano-cage coating. The coated polymer separator membrane may be fabricated through a sequence of irradiation, surface activation, coating, and curing processes. In particular, the fabrication process may include performing a first irradiation to a polymer separator membrane using an energy beam at a first radiation dose to modify the polymer separator membrane. Following the first irradiation, the irradiated polymer separator membrane may be subjected to a plasma treatment to generate active surface sites. A nano-cage precursor composition is then applied onto the plasma-treated surface of the polymer separator membrane to form a coating layer. Thereafter, a second irradiation is performed at a second radiation dose using the UV light to cure the precursor coating layer and form the inside-out cross-linked nano-cage coating on the polymer separator membrane.

The nano-cage precursor composition includes nano-cage molecules and a photo-initiator. The nano-cage molecules include cross-linkable functional groups comprising epoxy groups and/or carbon-carbon double bonds, enabling cross-linking reactions during the second irradiation step to form the inside-out cross-linked nano-cage coating. In certain embodiments, the cross-linking reaction is initiated at the interface between the modified separator surface and the nano-cage precursor layer and progressively propagates outward through the coating layer. This inside-out cross-linking mechanism creates a mechanically integrated coating network anchored to the separator surface, thereby enhancing coating adhesion and structural stability. In certain embodiments, the inside-out cross-linked nano-cage coating is in an ultra-thin form that increases the thermal stability of the polymer separator membrane without substantially increasing the thickness of the separator.

In addition, the first radiation dose used during the first irradiation is different from the second radiation dose used during the second irradiation. The sequential irradiation process not only promotes surface activation and cross-linking of the separator material but also facilitates the formation of a thermally stable nano-cage network that reinforces the separator while maintaining its porosity and ion transport characteristics.

The nano-cage coating also functions to capture electrolyte decomposition byproducts generated during electrochemical reactions. The nano-cage structures may include accessible cavities, porous frameworks, or active sites capable of interacting with reactive species formed during battery cycling. These structural features allow the nano-cage coating to trap or stabilize undesirable byproducts, thereby reducing accumulation of degradation products at the electrode-separator interface and improving long-term electrochemical stability of the cell.

The separator membrane suppresses dendrite growth between the anode and the cathode. The presence of the nano-cage coating and the irradiation-induced modification of the separator membrane enhance mechanical strength, structural stability, and interfacial uniformity of the separator layer. These properties help regulate ionic flux across the separator and reduce localized current density variations that can lead to dendrite formation. As a result, the separator membrane contributes to improved safety and extended cycle life of the electrochemical cell by mitigating the risk of dendritic short circuits between the electrodes.

### EXAMPLES

### Example 1. Rod Coating

A coating composition is prepared by dissolving 1-30 wt. % glycidyl polyhedral oligomeric silsesquioxane (named A-POSS) in 70-99 wt. % ethyl acetate (EA) as a solvent, with the total composition being 100 wt. %. In addition, 0.04 wt. % triarylsulfonium hexafluoroantimonate (TSHFA) is added as a curing agent. The mixture is subjected to ultrasonication to improve homogeneity and to ensure uniform dispersion of the POSS molecules within the solvent system, thereby forming a stable coating solution.

Prior to coating, a polyethylene (PE) separator film serving as the base substrate is subjected to oxygen plasma treatment to activate the surface and improve coating adhesion. The plasma treatment is carried out under conditions of 50 W plasma power, 30 seconds treatment time, and 0.3 mbar O₂ pressure. This surface treatment introduces polar functional groups onto the surface of the PE separator, thereby improving the affinity between the separator substrate and the subsequently applied coating layer.

Following surface activation, the prepared coating solution is applied to the PE separator using a rod-coating technique. The coating solution is first drop-cast onto one edge of the separator film positioned on a vacuum coating machine, and then evenly spread across the surface using a wire rod having a 5 μm gap width. The coating process is conducted at a coating speed of approximately 25 mm/s, allowing the solution to be uniformly distributed throughout the separator membrane.

After coating, the film is subjected to a drying process under vacuum at 60° C. for at least 10 minutes to remove the solvent and form a nano-coating layer on the PE fiber inside the separator membrane. Subsequently, the coated film is exposed to UV irradiation for curing, with the light intensity progressively increased according to the curing program of the UV system. Specifically, the film is irradiated at 35% light intensity for 60 seconds, followed by 70% intensity for 60 seconds, and finally 90% intensity for 120 seconds to achieve complete curing of the coating layer.

### Example 2. Spray Coating

A coating composition is prepared by dissolving 1 wt. % A-POSS in 99 wt. % EA as a solvent, resulting in a total composition of 100 wt. %. Additionally, 0.04 wt. % TSHFA is added as a curing agent. The mixture is subjected to ultrasonication to ensure homogeneous dispersion of the A-POSS molecules within the solvent and to produce a stable coating solution suitable for spray deposition.

Prior to coating, a PE separator film serving as the base substrate is subjected to oxygen plasma treatment in order to improve the adhesion of the coating layer. The plasma treatment is conducted under conditions of 50 W plasma power, 30 seconds treatment time, and 0.3 mbar O₂ pressure. This treatment introduces polar functional groups onto the surface of the PE separator, thereby improving surface energy and promoting bonding between the separator substrate and the subsequently applied coating layer.

Following surface treatment, the prepared coating solution is applied to the separator film using an ultrasonic spray coating system. The coating solution is first placed into the reservoir of the ultrasonic spray coater, while the PE separator film is positioned on a vacuum base plate to secure the substrate during coating. Prior to initiating the spray process, the nozzle movement parameters are configured, including a nozzle moving speed ranging from 50 to 100 mm/s, the designated movement area, and the programmed motion path of the nozzle. The spray coating process is then carried out for one to two coating cycles to deposit the coating solution onto the separator surface, then penetrating into the separator membrane. After coating, the uniformity of the deposited layer is visually inspected to confirm that the coating is homogeneous and that no transparent or uncoated regions remain on the separator surface.

The coated separator film is subsequently subjected to a drying step under vacuum at 60° C. for at least 10 minutes in order to remove the solvent and form a dry coating layer on the PE fiber inside the separator membrane. Following solvent removal, the coating layer is cured by UV irradiation, with the light intensity gradually increased according to the curing program of the UV system. Specifically, the film is irradiated at 35% intensity for 60 seconds, followed by 70% intensity for 60 seconds, and finally 90% intensity for 120 seconds, thereby completing the curing process.

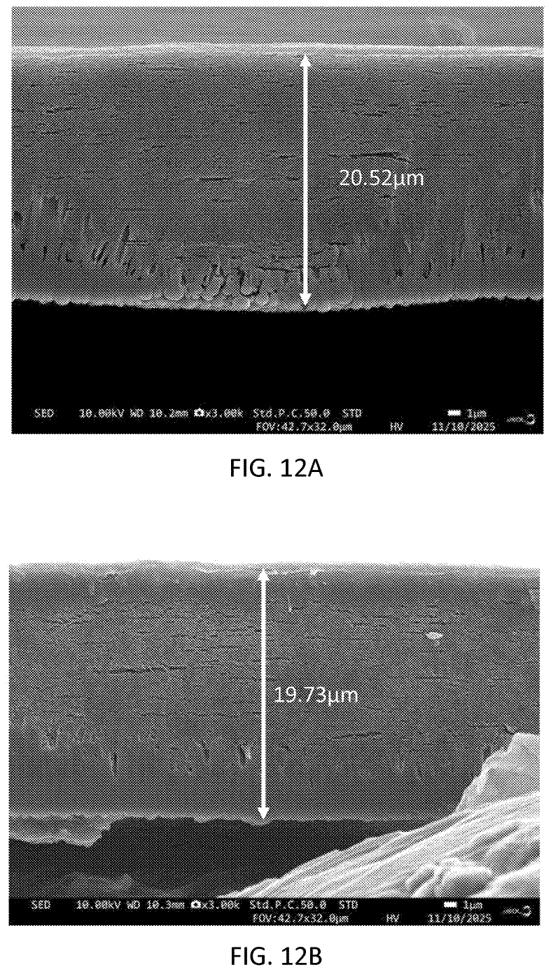

As shown in FIGS. 12A and 12B, when compared with the non-coated separator film, no appreciable increase in thickness is detected after the coating process, and the porous structure in the separator is retained-indicating that the applied coating layer is extremely thin. The thickness variation between the two measurements presented in FIGS. 12A and 12B is attributable to random measurement error under cross-section observation by the scanning electron microscope.

### Example 3. Thermal Shrinkage Test

The resulting dry separator film obtained from the coating and curing process (1% and 30% A-POSS solution coating) is trimmed into square samples measuring 66 mm×66 mm. The samples are then placed in a vacuum oven and subjected to an elevated temperature of 150° C. for 30 minutes while slight external pressure is applied. After the heat treatment, the dimensional changes of the separator samples are measured to evaluate the thermal shrinkage behavior of the film. The shrinkage ratios are determined in both the machine direction (MD) and the transverse direction (TD) to assess the thermal stability of the coated separator membrane. It is worth noting that the thermal shrinkage test performed in this embodiment is conducted on the glass plate, namely, there is no electrolyte.

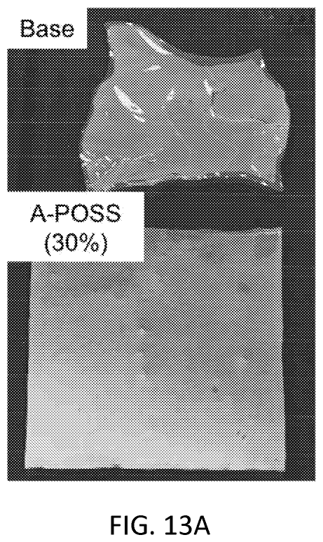

As shown in FIG. 13A, the base samples exhibit significant free deformation with partially transparent regions after 30 minute thermal treatment at 150° C. In contrast, the samples containing A-POSS show only slight shrinkage in both the machine direction and the transverse direction, and a gradient coloration can be observed on the sample surface. The corresponding quantitative shrinkage data are presented in FIG. 13B.

Additionally, different separators are tested as well. The 150° C. thermal shrinkage test is performed on the separators as listed in Table 1.

TABLE 1

| Sample | Composition | Thickness (μm) |
|---|---|---|
| Base | PE | 19-20 |
| A-POSS coating | PE with nano-cage | 19-20 |
| | coating (1% and 30% | |
| | solution) | |
| 20 + 4 | PE with ceramic | 24 |
| TOB-16A | PP/PE/PP | 16-17 |
| | (with super thin-adhesive) | |
| THM1222 | PE with aramid | 12 + 2 + 2 |

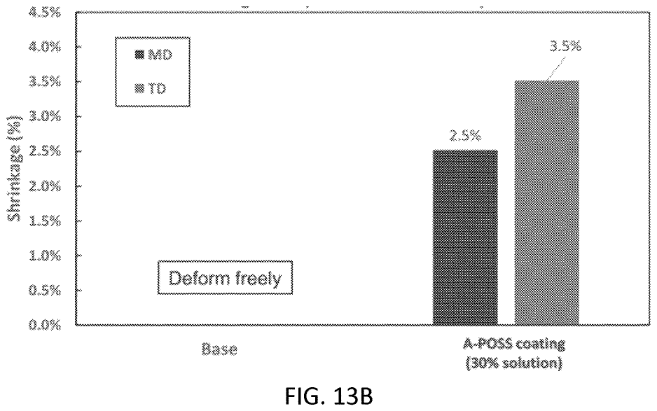

As shown in FIG. 14, the results indicate that the samples coated with 1% and 30% A-POSS exhibit the lowest degree of thermal shrinkage among the tested separators, demonstrating the effectiveness of the A-POSS nano-cage coating in improving the thermal dimensional stability of the separator membrane.

### Example 4. Rate Performance Test

To evaluate electrochemical performance, separator disks with a diameter of 16 mm are punched from the resulting dry film and used for coin cell assembly. The electrochemical cells are assembled in CR2032 coin cell format, using a cathode with a diameter of 12 mm and an anode with a diameter of 14 mm, corresponding to an anode-to-cathode (A/C) capacity ratio of approximately 1.1. An electrolyte volume of 80 μL is introduced into each cell. The electrolyte consisted of 1 M LiPF₆ dissolved in a mixed solvent of ethylene carbonate (EC) and ethyl methyl carbonate (EMC) in a volume ratio of 2:8, with an additional 0.5 wt. % vinylene carbonate (VC) as an additive.

The assembled cells are subsequently subjected to charge-discharge testing at various C-rates ranging from 0.1C to 5C within a voltage window of 3.0 V to 4.3 V. The rate capability of the cells is evaluated by comparing discharge capacities obtained at the different current rates.

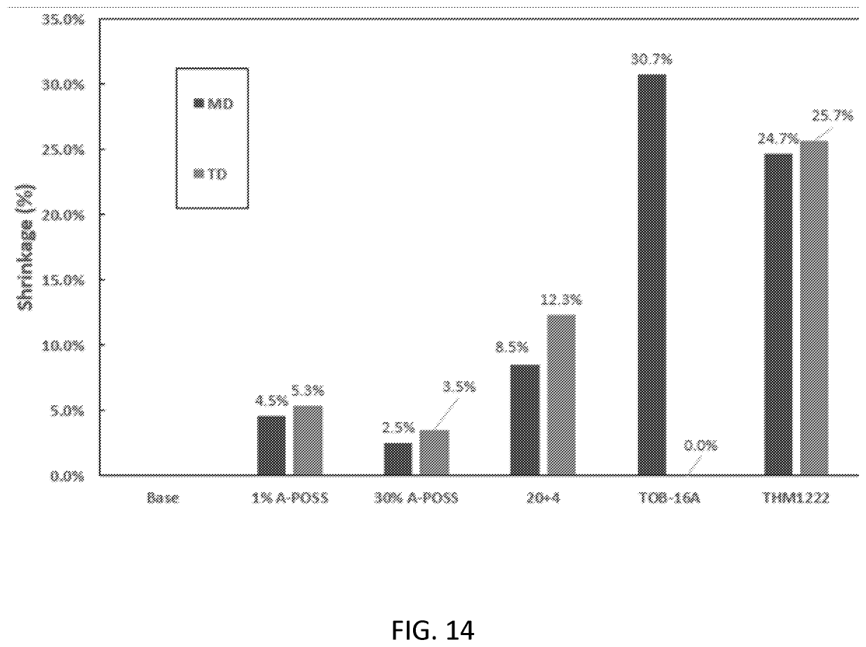

As shown in FIG. 15, the C-rate results showed that the samples coated with A-POSS (30%) were unable to normally charge and discharge among base separators and separators with ceramic coating (20+4), indicating the 30% concentration has led to partially to complete pore blockage, hindering the lithium-ion transport.

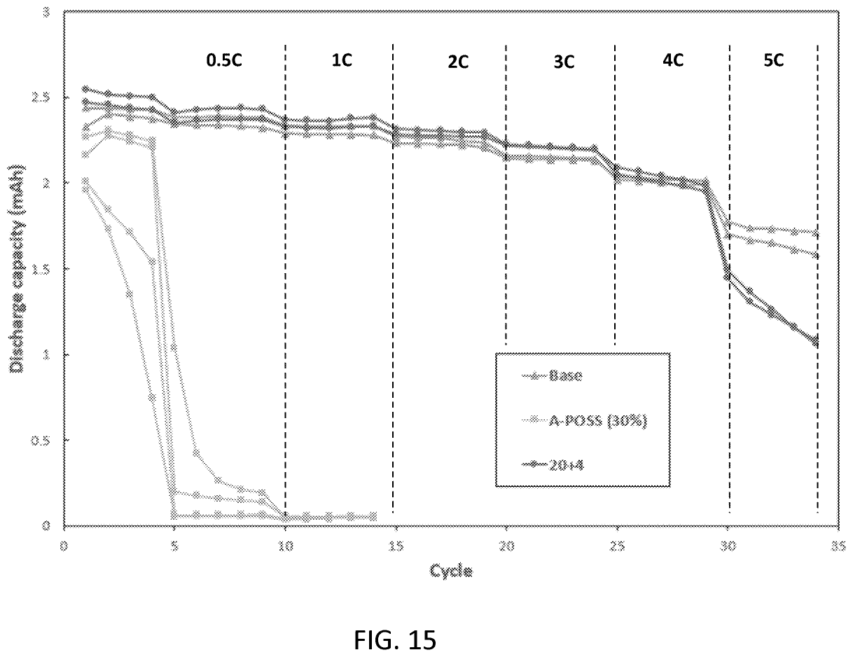

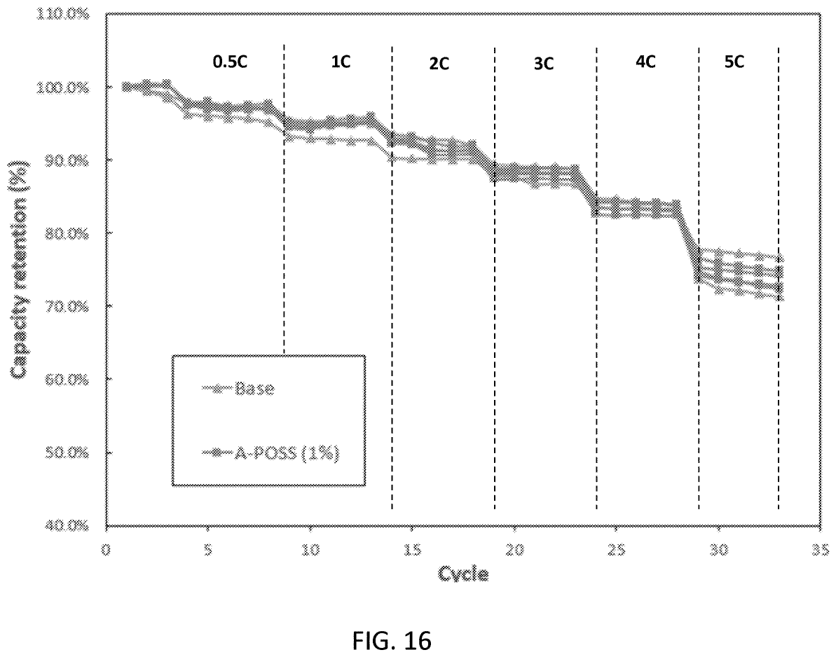

As shown in FIG. 16, the results showed that the samples coated with A-POSS (1%) had similar rate performances as base separator, indicating the 1% concentration has insignificant effects towards the pore size compared to the base, an indication of almost no pore blockage, thus no significant impact on battery performances.

In addition to the structural and functional advantages described above, the nano-cage coating applied to the polymer separator membrane provides several unexpected technical effects. Conventional separator modification approaches typically rely on polymer binders, ceramic particle coatings, or thick inorganic reinforcement layers to improve thermal stability or mechanical strength. However, these approaches often increase separator thickness, reduce electrolyte wettability, or introduce additional interfacial resistance, which can negatively affect battery energy density and electrochemical performance.

In contrast, the nano-cage coating described herein provides a multifunctional separator modification that simultaneously improves thermal stability, electrolyte wettability, and electrochemical stability without significantly increasing separator thickness or weight. Due to the intrinsic cage-like structure and high thermal stability of the nano cages, the coating layer provides mechanical reinforcement and thermal resistance while remaining thin and lightweight. As a result, the separator maintains dimensional stability under elevated temperatures while preserving the high energy density requirements of advanced electrochemical cells.

Furthermore, the nano-cage structures exhibit unexpected interfacial functionality. The presence of accessible cavities and open metal coordination sites within the nano-cages enables interactions with electrolyte ions and reaction intermediates. These features allow the nano-cages to stabilize anionic species and capture undesirable electrolyte decomposition byproducts. Such behavior is not observed in conventional ceramic or polymer coating systems, which typically function only as passive protective layers. Through these interactions, the nano-cage coating reduces interfacial impedance growth and suppresses gas generation during battery operation.

Additionally, the high polarity of the nano-cage coating enhances electrolyte wettability, which promotes rapid electrolyte infiltration and uniform ionic transport through the separator membrane. This improved electrolyte compatibility contributes to enhanced rate capability and more stable cycling performance. Importantly, these improvements are achieved without sacrificing separator mechanical properties or increasing separator thickness.

Accordingly, the nano-cage coating provides a synergistic combination of thermal stability, mechanical reinforcement, electrolyte affinity, and interfacial chemical functionality. The ability of a single ultra-thin coating layer to simultaneously provide these multiple benefits is unexpected in view of conventional separator modification technologies. As a result, the nano-cage coated separator membrane significantly improves battery safety, rate performance, and cycle life while maintaining compatibility with high energy density battery designs.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. The term “substantially coplanar” may refer to two surfaces within a few micrometers (m) positioned along the same plane, for example, within 10 μm, within 5 μm, within 1 μm, or within 0.5 μm located along the same plane. When reference is made to “substantially” the same numerical value or characteristic, the term may refer to a value within ±10%, ±5%, ±1%, or ±0.5% of the average of the values.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

1. A method of manufacturing an electrochemical cell having a polymer separator membrane with an inside-out cross-linked nano-cage coating for separation of electrodes in the electrochemical cell comprising:
providing a cathode;
providing a polymer separator membrane;
performing at least one cycle of irradiation on the polymer separator membrane by an energy beam under a radiation dose ranging between 50 and 200 kGy to effect a cross-linking in the polymer separator membrane, wherein the polymer separator membrane is maintained at a temperature between 3° and 70° C.;
subjecting irradiated polymer separator membrane to a plasma treatment to generate active surface sites;
applying a nano-cage precursor composition onto the plasma-treated surface of the polymer separator membrane to form a coating layer, wherein the nano-cage precursor composition comprises nano-cage molecules and a photo-initiator, and wherein the nano-cage molecules comprise cross-linkable functional groups comprising epoxy groups and/or carbon-carbon double bonds;
performing a second irradiation at a second radiation energy density ranging from 1 to 10000 mJ/cm² using the ultraviolet light to cure the precursor coating layer and form an inside-out cross-linked nano-cage coating on the polymer separator membrane, wherein the inside-out cross-linked nano-cage coating is configured to improve the thermal stability, facilitate electrolyte wetting of the polymer separator membrane, stabilize anions, and capture electrolyte byproducts;
providing an anode;
compressing the polymer separator membrane between the cathode and the anode; and
providing an electrolyte to form the electrochemical cell.

2. The method of claim 1, further comprising evaporating a solvent from the nano-cage precursor composition to form a thin precursor coating layer before performing the second irradiation.

3. The method of claim 2, wherein the inside-out cross-linked nano-cage coating is in an ultra-thin form that increases thermal stability of the polymer separator membrane without substantially increasing separator thickness.

4. The method of claim 1, wherein after performing at least one cycle of irradiation on the polymer separator membrane by the energy beam the polymer separator membrane has a gel content of cross-linked polymer separator membrane between 30% and 90%.

5. The method of claim 1, wherein the polymer separator membrane is selected from the group consisting of polypropylene, polyethylene, polyvinylidene difluoride, polyimide, polyacrylonitrile or combinations thereof.

6. The method of claim 1, wherein after the compressing the polymer separator membrane between the cathode and the anode, the polymer separator membrane has a thickness in a range between 3 μm and 30 μm.

7. The method of claim 1, wherein the inside-out cross-linked nano-cage coating comprises a polyhedral oligomeric silsesquioxane (POSS) and at least one metal-organic cage (MOC).

8. The method of claim 7, wherein the POSS is identified by an infrared (IR) absorption band between 1000 and 1200 cm⁻¹ in a Fourier transform infrared spectroscopy (FTIR) spectrum, corresponding to the key chemical bonds (Si—O—Si).

9. The method of claim 7, wherein the at least one MOC comprises metal clusters coordinated with organic ligands to form a porous cage structure having accessible internal cavities and open metal coordination sites capable of interacting with electrolyte species.

10. The method of claim 1, wherein the inside-out cross-linked nano-cage coating has a thickness of 0.1 nm to 50 nm.

11. The method of claim 1, wherein providing a polymer separator membrane further comprising:
applying polymeric binders on opposing sides of the polymer separator membrane; and
disposing a plurality of ceramic particles in the polymeric binders.

12. The method of claim 11, wherein the ceramic particles is selected from the group consisting of CaO nanoparticles, MgO nanoparticles, Al₂O₃ nanoparticles, B₂O₃ nanoparticles, SiO₂ nanoparticles, ZrO₂ nanoparticles, SnO₂ nanoparticles, nanoclay, or a combination thereof.

13. The method of claim 11, wherein the polymeric binder is selected from the groups consisting of silane, acrylate, epoxy, urethane, polyolefin, ether, and a combination thereof.

14. The method of claim 1, wherein the providing the polymer separator membrane further comprising:
manufacturing the polymer separator membrane by wet or dry extrusion, electrospinning, melt spinning, or a combination thereof.

15. The method of claim 1, wherein the first irradiations on the polymer separator membrane by the energy beam is an electron beam or a gamma ray.

16. An electrochemical cell comprising:
a cathode;
an anode;
an electrolyte; and
a coated polymer separator membrane disposed between the cathode and the anode;
wherein the coated polymer separator membrane comprises an inside-out cross-linked nano-cage coating;
wherein the coated polymer separator membrane is fabricated by performing a first irradiation to a polymer separator membrane using an energy beam at a first radiation dose for a first duration to modify the polymer separator membrane; subjecting the irradiated polymer separator membrane to a plasma treatment to generate active surface sites; applying a nano-cage precursor composition onto the plasma-treated surface of the polymer separator membrane to form a coating layer; performing a second irradiation at a second radiation energy density using the UV light to cure the precursor coating layer and form the inside-out cross-linked nano-cage coating of the polymer separator membrane;
wherein the nano-cage precursor composition comprises nano-cage molecules and a photo-initiator, and wherein the nano-cage molecules comprise cross-linkable functional groups comprising epoxy groups and/or carbon-carbon double bonds;
wherein the inside-out cross-linked nano-cage coating is in an ultra-thin form that increases thermal stability of the polymer separator membrane without substantially increasing separator thickness;
wherein the first radiation dose is ranging from 100 to 200 kGy; and
wherein the second radiation energy density is ranging from 1 to 10000 mJ/cm².

17. The electrochemical cell of claim 16, wherein the inside-out cross-linked nano-cage coating is an enhancer of electrolyte wettability of the separator membrane.

18. The electrochemical cell of claim 16, wherein the inside-out cross-linked nano-cage coating is configured to capture electrolyte decomposition byproducts.

19. The electrochemical cell of claim 16, wherein the coated separator membrane is a suppressor of dendrite growth between the anode and cathode.
